(19) United States
(12) Patent Application Publication
(10) Pub. No.: US 2006/0271869 A1
(43) Pub. Date: Nov. 30, 2006

(54) Custom task panes that provide accessibility to one or more functions of an application program

(75) Inventors: Lakshmi Narayanan Thanu, Sammamish, WA (US); Peter Eberhardy, Seattle, WA (US); Mark Xiaohong Yang, Sammamish, WA (US)

Correspondence Address: MICROSOFT CORPORATION;ATTN: PATENT GROUP DOCKETING DEPARTMENT, ONE MICROSOFT WAY, REDMOND, WA, 98052-6399, US

(73) Assignee: Microsoft Corporation, Redmond, WA (US)

(21) Appl. No.: 11/142,064

(22) Filed: May 31, 2005

(51) Int. Cl. G06F 9/00

(52) U.S. Cl. 715/764

(57) ABSTRACT

Methods of providing (1) additional functionality and/or (2) accessibility to user functions in a software application program are disclosed. Computer readable medium having stored thereon computer-executable instructions for performing methods of providing (1) additional functionality and/or (2) accessibility to user functions in a software application program are disclosed. Further, computing systems containing at least one application module, wherein the at least one application module comprises application code for performing methods of (1) additional functionality and/or (2) accessibility to user functions in a software application program are disclosed.

### BACKGROUND

A variety of software application programs exist today. Once loaded onto a computing system, the original software application program provides a set of functions to a user (e.g., functions A₁ through A_{M} where M is an integer). The set of functions, or functionality, of the original software application program is limited to the original code used to create the original software application program. Further, accessibility to one or more functions in the original software application program is limited to the accessibility provided in the original code of the software application program.

There exists a need in the art to provide (1) ease of access to functions within a given original software application program and/or (2) additional functionality not provided in the original software application program without sacrificing or decreasing the functionality provided in the original software application program.

### SUMMARY

Described herein are, among other things, various technologies for providing (1) additional functionality to an existing software application program, (2) accessibility to user functions in the existing software application program, or both (1) and (2). The additional functionality and/or accessibility may be presented to a user via a custom task pane provided in a window display of the application program. The custom task pane may be used to provide (i) one or more functions that are not provided in the original application program, (ii) one or more functions that are provided in the original application program, but are not provided in a task pane of the original application program, or (iii) both (i) and (ii).

This Summary is provided to generally introduce the reader to one or more select concepts describe below in the “Detailed Description” section in a simplified form. This Summary is not intended to identify key and/or required features of the claimed subject matter.

### BRIEF DESCRIPTION OF THE FIGURES

FIG. 1 depicts an exemplary window displayed to a user when an exemplary application program is selected by the user, wherein the window comprises a custom task pane providing functions B₁ through B_{N} to the user;

FIG. 2 depicts an exemplary window displayed to a user when an exemplary application program is selected by the user, wherein the window comprises (i) a native task pane providing functions A₁ through A_{N} to the user, and (ii) a custom task pane providing functions B₁ through B_{N} to the user;

FIG. 3 is a block diagram of some of the primary components of an exemplary operating environment for implementation of the methods and processes disclosed herein;

FIGS. 4A-4D represent a flow diagram showing exemplary steps in a method of generating and displaying a custom task pane in a window of an application program;

FIG. 5 depicts an exemplary screenshot of an exemplary application program prior to loading an exemplary application program add-in onto a computing system, wherein the add-in provides a custom task pane to a user;

FIG. 6 depicts an exemplary screenshot of an exemplary application program after loading an exemplary application program add-in onto a computing system, wherein the add-in provides a custom task pane to a user;

FIG. 7 depicts an exemplary screenshot of an exemplary application program, wherein an exemplary report-building custom task pane is provided to a user; and

FIG. 8 depicts an exemplary screenshot of an exemplary application program after a layout pane function of an exemplary report-building custom task pane has been selected by a user.

### DETAILED DESCRIPTION

To promote an understanding of the principles of the methods and processes disclosed herein, descriptions of specific embodiments follow and specific language is used to describe the specific embodiments. It will nevertheless be understood that no limitation of the scope of the disclosed methods and processes is intended by the use of specific language. Alterations, further modifications, and such further applications of the principles of the disclosed methods and processes discussed are contemplated as would normally occur to one ordinarily skilled in the art to which the disclosed methods and processes pertains.

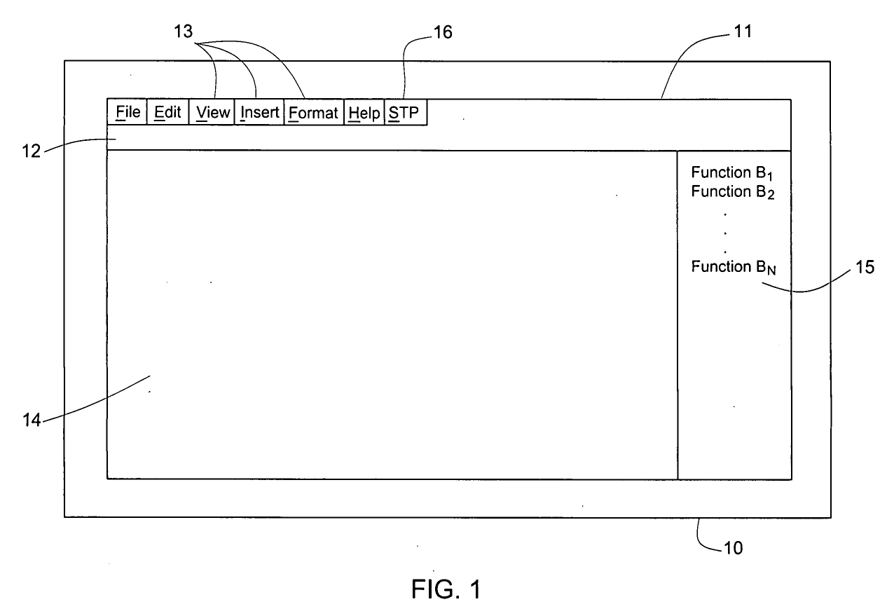

Methods of providing (1) additional functionality and/or (2) accessibility to user functions in a software application program are disclosed. The (1) additional functionality and/or (2) accessibility to user functions may be presented to a user via a custom task pane provided in a window display of the application program. The custom task pane may be used to provide (i) one or more functions to a user, wherein the one or more functions are not provided in the original application program, (ii) one or more functions to a user, wherein the one or more functions are provided in the original application program, but not provided in a task pane of the original application program, or (iii) both (i) and (ii). An exemplary custom task pane suitable for use in the disclosed methods is shown as exemplary custom task pane 15 in FIG. 1.

FIG. 1 depicts an exemplary window 11 displayed to a user on desktop 10 when an exemplary application program is selected by the user. Exemplary window 11 comprises the following components displayed therein: tool menu bar 12, main window 14, and exemplary custom task pane 15. Tool menu bar 12 provides various tool bar functions 13 to a user in order to perform one or more tasks within a given application program file. As shown in FIG. 1, tool bar functions 13 may include, but are not limited to, “File” functions (e.g., creating a new file, opening an existing file, and saving a file), “Edit” functions (e.g., selecting text within a file, finding text within a file, and replacing text within a file), and other functions. Main window 14 provides a window area for direct input of data (e.g., words, numbers, etc.) by a user. For example, in a spreadsheet application program, such as the EXCEL spreadsheet application program commercially available from Microsoft Corporation (Redmond, Wash.), main window 14 would be the spreadsheet area of rows and columns displayed to a user.

Exemplary custom task pane 15 is shown on the right side of window 11. Exemplary custom task pane 15 provides functions B₁ through B_{N}, where N is an integer. Typically, N is greater than 1; however, it should be understood that N can equal 1 in some embodiments of the disclosed methods. Further, although exemplary custom task pane 15 is shown on the right side of window 11, it should be noted that the custom task pane may be present in any location on the desktop of a given application program display.

As discussed in more detail below, the custom task pane may be accessible by a user or presented to a user via one or more operations. In the exemplary embodiment shown in FIG. 1, exemplary custom task pane 15 is displayed to a user in response to the user selecting one of tool bar functions 13. Once a user selects STP tool bar function 16, exemplary custom task pane 15 appears in window 11.

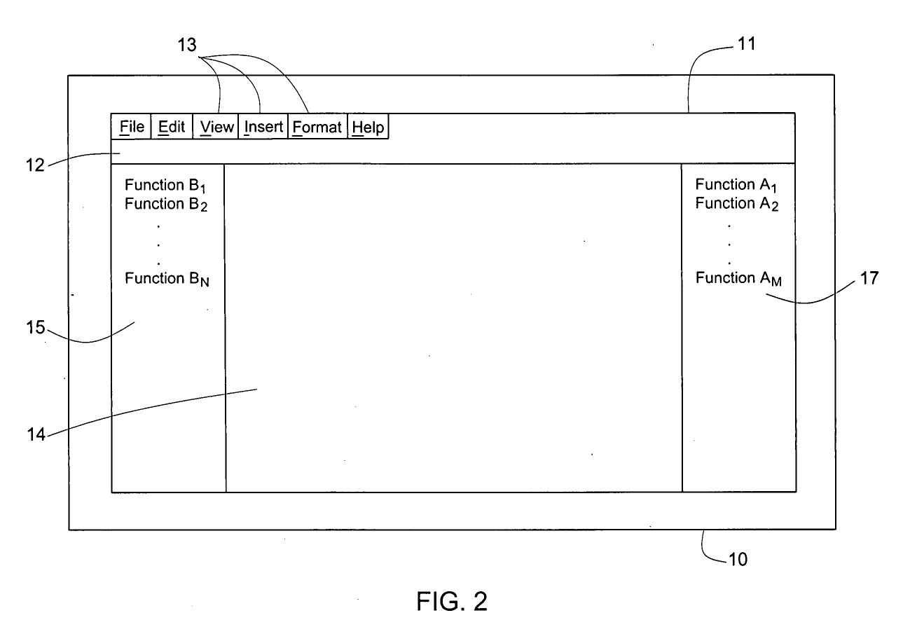

The methods disclosed herein may be practiced using application programs, which do not provide a task pane to a user, as well as application programs that provide one or more “native” task panes to a user. As used herein, the term “native task pane” refers to a task pane provided to a user in an original software application program. An exemplary embodiment, wherein a custom task pane is provided along with one or more native task panes, is shown in FIG. 2.

FIG. 2 depicts an exemplary window 11 displayed to a user on desktop 10 when an exemplary application program containing one or more native task panes is utilized by the user. As in the exemplary embodiment shown in FIG. 1, exemplary window 11 shown in FIG. 2 comprises the following components displayed therein: tool menu bar 12, main window 14, and exemplary custom task pane 15. In addition, exemplary window 11 comprises native task pane 17. In this exemplary embodiment, exemplary custom task pane 15 is shown on the left side of window 11, while exemplary native task pane 17 is shown on the right side of window 11. It should be understood that custom task panes of the methods disclosed herein, and native task panes of a given application program may be located in other locations along the desktop of a given application program.

As shown in FIG. 2, exemplary native task pane 17 provides functions A₁ through A_{M} to a user where M is an integer, while exemplary custom task pane 15 provides functions B₁ through B_{N}, where N is an integer as described above. Like N, typically M is greater than 1; however, it should be understood that M can equal 1 in some embodiments. In this exemplary embodiment, functions B₁ through B_{N} are either (i) not provided in the original application program or (ii) are provided in the original application program, but are not provided in exemplary native task pane 17.

In the exemplary embodiment shown in FIG. 2, the custom task pane is accessible by a user via an operation other than one of tool bar functions 13. For example, exemplary custom task pane 15 may be displayed to a user in response to the user selecting one of functions A₁ through A_{M} provided in exemplary native task pane 17. Alternatively, exemplary custom task pane 15 may be displayed to a user in response to the user right clicking on a portion of window 11, such as main window area 14. In yet a further alternative, exemplary custom task pane 15 may be displayed to a user in response to starting the application program (i.e., exemplary custom task pane 15 automatically appears in window 11 when the application program is initiated by a user).

Application programs using the custom task pane of the methods disclosed herein may be loaded and executed on a variety of computer systems comprising a variety of hardware components. An exemplary computer system and exemplary operating environment for practicing the methods disclosed herein is described below.

Exemplary Operating Environment

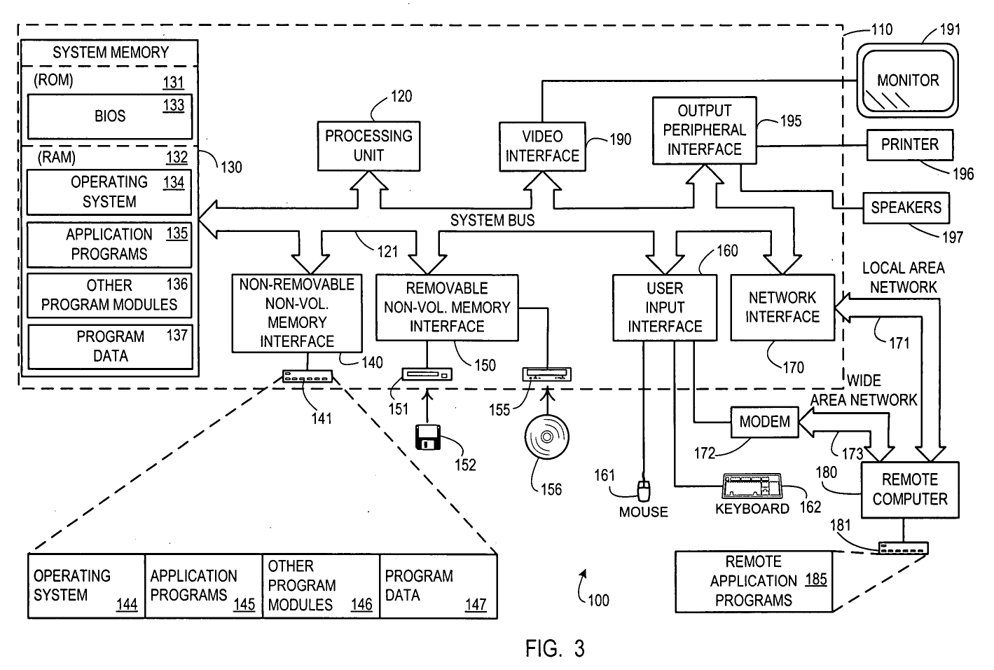

FIG. 3 illustrates an example of a suitable computing system environment 100 on which the methods disclosed herein may be implemented. The computing system environment 100 is only one example of a suitable computing environment and is not intended to suggest any limitation as to the scope of use or functionality of the methods disclosed herein. Neither should the computing environment 100 be interpreted as having any dependency or requirement relating to any one or combination of components illustrated in the exemplary operating environment 100.

The methods disclosed herein are operational with numerous other general purpose or special purpose computing system environments or configurations. Examples of well-known computing systems, environments, and/or configurations that may be suitable for use with the methods disclosed herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The methods and processes disclosed herein may be described in the general context of computer-executable instructions, such as program modules, being executed by a computer. Generally, program modules include routines, programs, objects, components, data structures, etc. that perform particular tasks or implement particular abstract data types. The methods and processes disclosed herein may also be practiced in distributed computing environments where tasks are performed by remote processing devices that are linked through a communications network. In a distributed computing environment, program modules may be located in both local and remote computer storage media including memory storage devices.

With reference to FIG. 3, an exemplary system for implementing the methods and processes disclosed herein includes a general purpose computing device in the form of a computer 110. Components of computer 110 may include, but are not limited to, a processing unit 120, a system memory 130, and a system bus 121 that couples various system components including, but not limited to, system memory 130 to processing unit 120. System bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium, which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media as used herein.

System memory 130 includes computer storage media in the form of volatile and/or nonvolatile memory such as read only memory (ROM) 131 and random access memory (RAM) 132. A basic input/output system 133 (BIOS) containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 3 illustrates operating system 134, application programs 135, other program modules 136, and program data 137.

Computer 110 may also include other removable/non-removable, volatile/nonvolatile computer storage media. By way of example only, FIG. 3 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. Hard disk drive 141 is typically connected to system bus 121 through a non-removable memory interface such as interface 140, and magnetic disk drive 151 and optical disk drive 155 are typically connected to system bus 121 by a removable memory interface, such as interface 150.

The drives and their associated computer storage media discussed above and illustrated in FIG. 3, provide storage of computer readable instructions, data structures, program modules and other data for computer 110. In FIG. 3, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to processing unit 120 through a user input interface 160 that is coupled to system bus 121, but may be connected by other interface and bus structures, such as a parallel port, game port or a universal serial bus (USB). A monitor 191 or other type of display device is also connected to system bus 121 via an interface, such as a video interface 190. In addition to monitor 191, computer 110 may also include other peripheral output devices such as speakers 197 and printer 196, which may be connected through an output peripheral interface 195.

Computer 110 may operate in a networked environment using logical connections to one or more remote computers, such as a remote computer 180. Remote computer 180 may be a personal computer, a server, a router, a network PC, a peer device or other common network node, and typically includes many or all of the elements described above relative to computer 110, although only a memory storage device 181 has been illustrated in FIG. 3. The logical connections depicted in FIG. 3 include a local area network (LAN) 171 and a wide area network (WAN) 173, but may also include other networks. Such networking environments are commonplace in offices, enterprise-wide computer networks, intranets and the Internet.

When used in a LAN networking environment, computer 110 is connected to LAN 171 through a network interface or adapter 170. When used in a WAN networking environment, computer 110 typically includes a modem 172 or other means for establishing communications over WAN 173, such as the Internet. Modem 172, which may be internal or external, may be connected to system bus 121 via user input interface 160, or other appropriate mechanism. In a networked environment, program modules depicted relative to computer 110, or portions thereof, may be stored in the remote memory storage device. By way of example, and not limitation, FIG. 3 illustrates remote application programs 185 as residing on memory device 181. It will be appreciated that the network connections shown are exemplary and other means of establishing a communications link between the computers may be used.

As mentioned above, those skilled in the art will appreciate that the disclosed methods of providing a custom task pane to a user may be implemented in other computer system configurations, including hand-held devices, multiprocessor systems, microprocessor-based or programmable consumer electronics, networked personal computers, minicomputers, mainframe computers, and the like. The disclosed methods of providing a custom task pane to a user may also be practiced in distributed computing environments, where tasks are performed by remote processing devices that are linked through a communications network. In a distributed computing environment, program modules may be located in both local and remote memory storage devices.

Implementation of Exemplary Embodiments

As discussed above, methods of providing (1) additional functionality and/or (2) accessibility to user functions of an original software application program are provided by presented a custom task pane to a user. The custom task pane may be used to provide (i) one or more functions to a user, wherein the one or more functions are not provided in the original application program, (ii) one or more functions to a user, wherein the one or more functions are provided in the original application program, but are not provided in a native task pane of the original application program, or (iii) both (i) and (ii).

The methods of providing a custom task pane to a user may be used in a variety of software application programs. Suitable software application programs include, but are not limited to, word-processing application programs, such as the WORD application program commercially available from Microsoft Corporation (Redmond, Wash.), and other word-processing application programs commercially available from any other software provider; spreadsheet application programs, such as the EXCEL application program commercially available from Microsoft Corporation (Redmond, Wash.), and other spreadsheet application programs commercially available from any other software provider; presentation application programs, such as the POWERPOINT application program commercially available from Microsoft Corporation (Redmond, Wash.), and other presentation application programs commercially available from any other software provider; and electronic mail application programs, such as the OUTLOOK application program commercially available from Microsoft Corporation (Redmond, Wash.), and other electronic mail application programs commercially available from any other software provider.

As discussed above, the custom task panes of the disclosed embodiments may provide one or more functions B₁ to B_{N} to a user, wherein the one or more functions are not provided in an original application program. There is no limit to the number of functions or the type of functions provided to a user by the custom task pane. Typically, the number of functions and the type of functions provided to a user by a given custom task pane depends on the application program utilizing the custom task pane. For example, in a word-processing or presentation application program, the custom task pane may be used to provide one or more functions relating to the translation of a word in a first language into a second language, or the display of words in a window display (e.g., main window 14 shown in FIGS. 1-2). In a spreadsheet application program, the custom task pane may be used to provide one or more functions relating to the creation of reports, or the display of numerical data in a window display (e.g., main window 14 shown in FIGS. 1-2). In other application programs, such as application programs used to draw or create figures (e.g., VISIO drawing software commercially available from Microsoft Corporation (Redmond, Wash.)) or chemical structures (e.g., CHEMDRAW drawing programs commercially available from Cambridgesoft (Cambridge, Mass.), the custom task pane may be used to provide one or more functions relating to the creation of drawings or structures in a window display (e.g., main window 14 shown in FIGS. 1-2).

Suitable functions B₁ to B_{N} that are not provided in an original application program and are provided to a user via one or more custom task panes may include, but are not limited to, a data importation function, a report building function, a drawing or figure generating function, a word processing function, a data manipulation function, or any combination thereof.

Further, as discussed above, the custom task pane may provide one or more functions B₁ to B_{N} to a user, wherein the one or more functions are provided in an original application program, but are not provided in a native task pane of the original application program. Suitable functions B₁ to B_{N} that are provided in an original application program, but are not provided in a native task pane of the original application program, for use in one or more custom task panes may include, but are not limited to, “File” functions (e.g., creating a new file (the “New” function), opening an existing file (the “Open” function), and saving a file (the “Save” function)); “Edit” functions (e.g., selecting text within a file (the “Select All” function), finding text within a file (the “Find” function), and replacing text within a file (the “Replace” function)); and any other function such as those found in the tool bar menu, the native task pane, or any other location of a given application program. Suitable functions may include, but are not limited to, those disclosed in any of the above-mentioned OFFICE application products commercially available from Microsoft Corporation (Redmond, Wash.) or any other application program commercially available from any other software provider.

The custom task pane and methods of utilizing the custom task pane may be provided on a computer readable medium having stored thereon computer-executable instructions for generating and displaying a custom task pane in an application program. The computer-executable instructions enable a user of the application program to (i) perform one or more functions that are not provided in the original application program; (ii) perform one or more functions that are provided in the original application program, but are not provided in a native task pane of the original application program; or (iii) both (i) and (ii).

In one exemplary embodiment, the original application program comprises a native task pane that provides a first set of functions (e.g., functions A₁ through A_{M}, where M is an integer) to a user; the custom task pane provides a second set of functions (e.g., functions B₁ through B_{N}, where N is an integer) to a user; and the second set of functions (e.g., functions B₁ through B_{N}, where N is an integer) is different from the first set of functions (e.g., functions A₁ through A_{M}, where M is an integer). Typically, the computer-executable instructions provide the second set of functions (e.g., functions B₁ through B_{N}, where N is an integer) to a user without removing or negatively impacting any functions in the first set of functions (e.g., functions A₁ through A_{M}, where M is an integer).

In a further embodiment, the computer-executable instructions for generating and displaying a custom task pane in an application program further comprise computer-executable instructions for resizing a window of the original application program when the custom task pane is displayed. In this embodiment, in response to an initiation step by a user to generate and display a custom task pane, the application program recognizes a signal or message to resize a window of the application program (e.g., main-window 14 as shown in FIGS. 1-2) so that (i) components of the window prior to displaying the custom task pane, and (ii) the custom task pane are simultaneously displayed to a user.

In embodiments wherein the application program comprises a native task pane, it may be desirable for the custom task pane to have a similar appearance of that of the native task pane. For example, the native task pane may have a first display layout viewable by a user, wherein the first display layout comprises first task pane dimensions and a first task pane color scheme. Desirably, the custom task pane has a second display layout viewable by a user, wherein the second display layout comprises the first task pane dimensions and the first task pane color scheme as used to display the native task pane.

Like the native task panes of many application programs (e.g., the native task panes found in the above-mentioned OFFICE application products commercially available from Microsoft Corporation (Redmond, Wash.)), the custom task panes generated in the methods disclosed herein are desirably capable of hovering and docking. As used herein, the term “hover” or “hovering” is used to describe the ability of the custom task pane to be moved by a user from a first location on a desktop (e.g., desktop 10 as shown in FIGS. 1-2) to a second location on the desktop, wherein neither, either or both of the first and second locations on the desktop are within a window (e.g., window 11 as shown in FIGS. 1-2) of an application program. Typically, the user clicks on a portion of the custom task pane using a device, such as a mouse (e.g., mouse 161 as shown in FIG. 3), and drags the custom pane from the first location to the second location.

Further, as used herein, the term “dock” or “docking” is used to describe the ability of the custom task pane to be stationed (e.g., anchored) by the application program in a docking station when the custom task pane is positioned over the docking station. Typically, the user clicks on a portion of the custom task pane using a device, such as a mouse (e.g., mouse 161 as shown in FIG. 3), drags the custom task pane to a docking station within a window (e.g., window 11 as shown in FIGS. 1-2) of the application program, and the application program anchors the custom task pane in the docking station. For example, application programs, such as the WORD application program and the EXCEL application program, both of which are commercially available from Microsoft Corporation (Redmond, Wash.), comprise four separate docking stations within a displayed window (e.g., window 11 as shown in FIGS. 1-2) of the application program: a docking station along a right-hand side of the window, a docking station along a left-hand side of the window, a docking station along an upper portion of the window below the tool bar menu, and a docking station along a lower portion of the window.

Method of generating and displaying a custom task pane in an application program are also disclosed. In one exemplary embodiment, the method comprises the steps of providing at least one application program feature, wherein initiation of the at least one application program feature by a user generates and displays a custom task pane to the user; and in response to an initiation step by a user, generating and displaying a custom task pane to the user, wherein the custom task pane enables a user to (i) perform one or more functions that are not provided in the application program; (ii) perform one or more functions that are provided in the application program, but not provided in a native task pane of the application program; or (iii) both (i) and (ii). In some embodiments, the at least one application program feature may comprise at least one tool bar menu option such that the initiation step comprises selecting the at least one tool bar menu option. In other embodiments, the at least one application program feature comprises at least one native task pane menu option such that the initiation step comprises selecting the at least one native task pane menu option. In other embodiments, the at least one application program feature comprises automatically displaying the custom task pane to the user when a window of the application program is displayed to the user. In this embodiment, the initiation step comprises opening the application program for use on a computing system by the user.

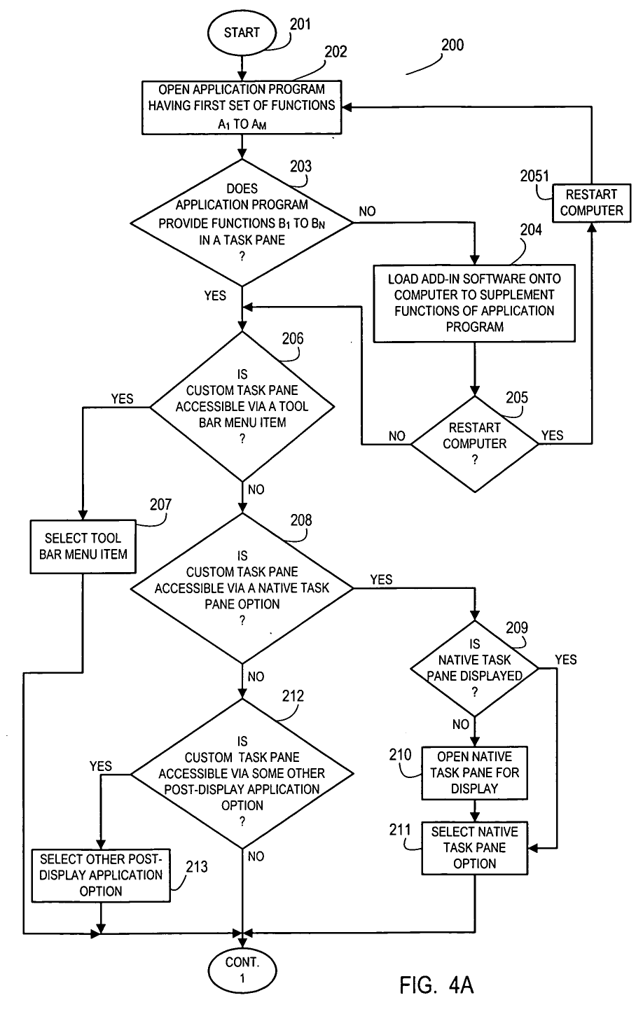

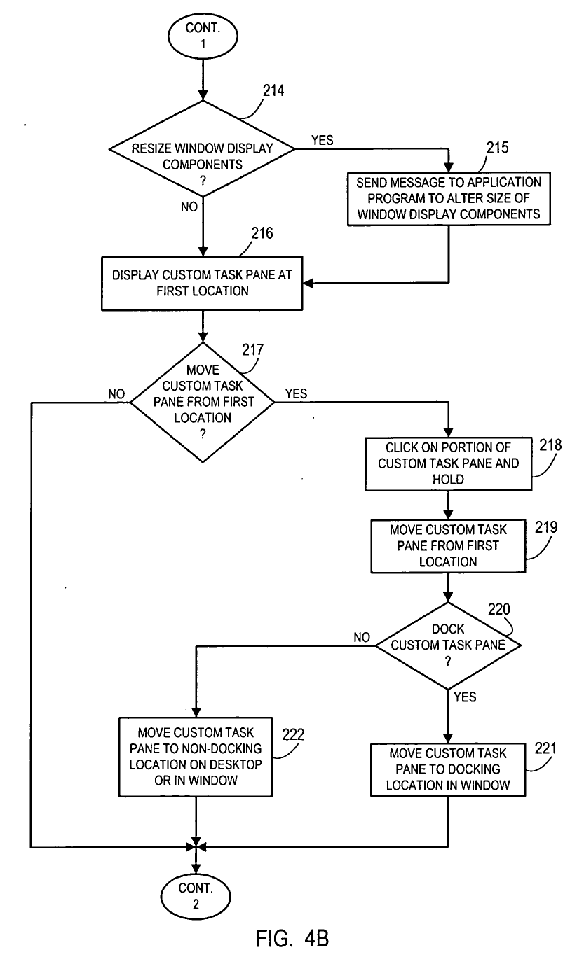

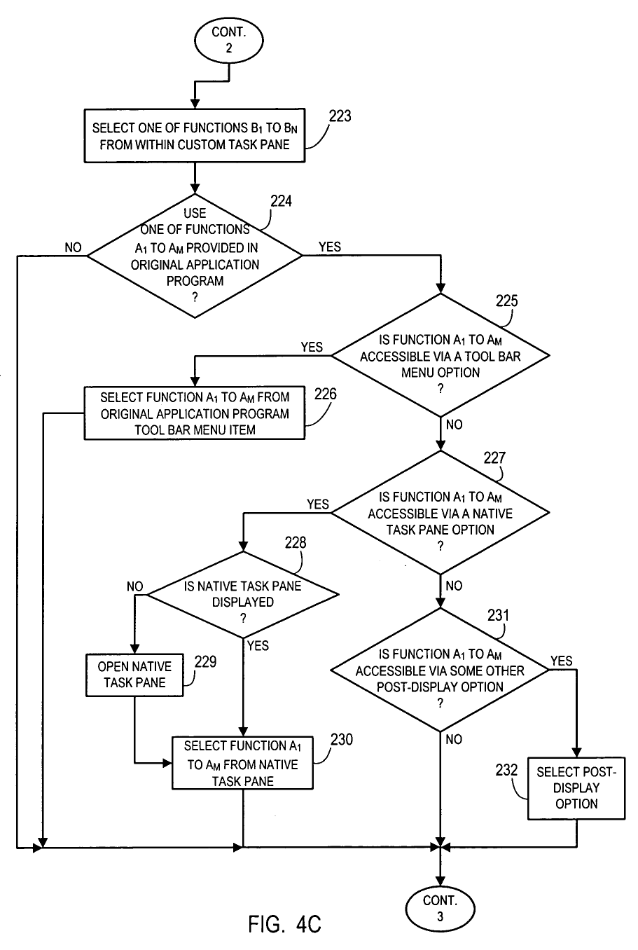

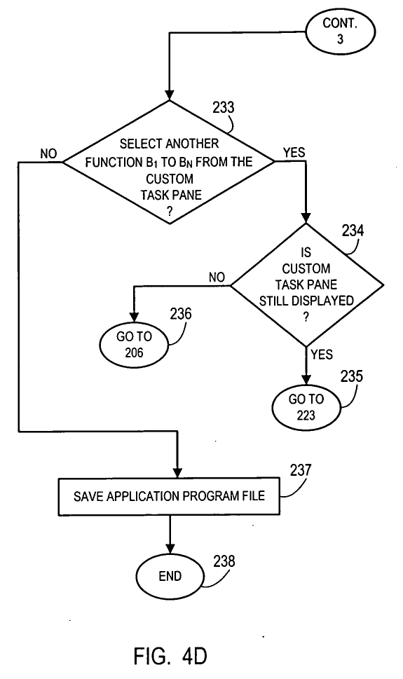

One exemplary method of generating and displaying a custom task pane in a window of an application program is described in a flow diagram shown in FIGS. 4A-4D. As shown in FIGS. 4A-4D, exemplary method 200 starts at start block 201 and proceeds to step 202, wherein an exemplary application program having a first set of functions A₁ to A_{M} is opened by a user (M being an integer as discussed above). Step 202 proceeds to decision block 203, wherein a determination is made by a user as to whether the application program provides functions B₁ to B_{N} in a task pane (N being an integer as discussed above). If the application program does not provide functions B₁ to B_{N} in a task pane, exemplary method 200 proceeds to step 204, wherein add-in software is loaded onto the computer or computing system to supplement the functionality of the original application program (i.e., provide a custom task pane containing functions B₁ to B_{N}). Loading add-in software onto the computer or computing system may comprise (1) installing add-in software onto the computer or computing system from a local source (e.g., within a local area network (LAN), see, for example LAN 171 in FIG. 3) using any of the above-described computer readable media, or (2) downloading add-in software onto the computer or computing system from an external source (e.g., within a wide area network (WAN), see, for example WAN 173 in FIG. 3).

Step 204 proceeds to decision block 205, wherein a determination is made by the user as to whether the computer loaded with the add-in software needs to be restarted. If the computer needs to be restarted after loading the add-in software, exemplary method 200 proceeds to step 2051, wherein the user restarts the computer. From step 2051, exemplary method 200 returns to step 202 described above. If at decision block 205 it is determined that the computer does not need to be restarted after loading the add-in software, exemplary method 200 proceeds to decision block 206 described below.

Returning to decision block 203, if a determination is made by the user that the application program does provide functions B₁ to B_{N} in a task pane, exemplary method 200 proceeds to decision block 206, wherein a determination is made by the user as to whether the custom task pane is accessible via a tool bar menu item. If the custom task pane is accessible via a tool bar menu item, exemplary method 200 proceeds to step 207, wherein a tool bar menu item is selected by the user, initiating display of the custom task pane. From step 207, exemplary method 200 proceeds to decision block 214 (shown in FIG. 4B) discussed below.

Returning to decision block 206, if a determination is made by the user that the custom task pane is not accessible via a tool bar menu item, exemplary method 200 proceeds to decision block 208, wherein a determination is made by the user as to whether the custom task pane is accessible via a native task pane option. If the custom task pane is accessible via a native task pane option, exemplary method 200 proceeds to decision block 209, wherein a determination is made by the user as to whether the native task pane is displayed to the user. If the native task pane is not displayed to the user, exemplary method 200 proceeds to step 210, wherein the native task pane is opened for display to the user. Step 210 then proceeds to step 211, wherein a native task pane option is selected by the user to initiate the display of the custom task pane. If at decision block 209 a determination is made by the user that the native task pane is displayed to the user, exemplary method 200 proceeds directly to step 211 bypassing step 210. From step 211, exemplary method 200 proceeds to decision block 214 (shown in FIG. 4B) discussed below.

Returning to decision block 208, if a determination is made by the user that the custom task pane is not accessible via a native task pane option, exemplary method 200 proceeds to decision block 212, wherein a determination is made by the user as to whether the custom task pane is accessible via some other post-display application option. As used herein, the term “post-display application option” refers to an option provided to the user after a window for a given application program is displayed to the user. Post-display application options include, but are not limited to, tool bar menu items, options provided in a native task pane, and options available to the user when the user right clicks on an application window (providing a menu of options to the user). Consequently, as used in decision block 212 of exemplary method 200 shown in FIGS. 4A-4D, the term “some other post-display application option” (i.e., other than tool bar menu items mentioned in decision block 206 and native task pane options mentioned in decision block 208) includes, but is not limited to, options available to the user when the user right clicks on an application window.

If at decision block 209 a determination is made by the user that the custom task pane is accessible via some other post-display application option (e.g., options available to the user when the user right clicks on an application window), exemplary method 200 proceeds to step 210, wherein some other post-display application option is selected by the user, initiating display of the custom task pane. From step 213, exemplary method 200 proceeds to decision block 214 (shown in FIG. 4B) discussed below.

Returning to decision block 212, if a determination is made by the user that the custom task pane is not accessible via some other post-display application option, exemplary method 200 proceeds directly to decision block 214 shown in FIG. 4B. It should be noted that exemplary method 200 proceeds directly from decision block 206 to decision block 208 to decision block 212 to decision block 214 in an embodiment wherein initiation of the display of the custom task pane takes place simply by starting the application program that generates and displays the custom task pane. In this embodiment, the custom task pane is automatically displayed to the user as a component of the window when the window of the application program is displayed to the user.

At decision block 214, a determination is made via application code of the add-in software as to whether the window display components (e.g., tool menu bar 12, main window 14, and native task pane 17 as shown in FIG. 2) within the window of the application program (e.g., window 11 as shown in FIG. 2) are to be resized so that the components and the custom task pane are viewable by a user. If at decision block 214 the add-in software loaded in step 204 (or already present on the computer) contains application code that resizes window display components (e.g., tool menu bar 12, main window 14, and native task pane 17 as shown in FIG. 2) within the window of the application program (e.g., window 11 as shown in FIG. 2) when displaying the custom task pane, exemplary method 200 proceeds to step 215, wherein a message is sent by application code of the add-in software to the original application program to alter the size of one or more of the window display components prior to display of the custom task pane. Step 215 then proceeds to step 216, wherein the custom task pane is displayed in a first location of the window.

Returning to decision block 214, if a determination is made that the window display components (e.g., tool menu bar 12, main window 14, and native task pane 17 as shown in FIG. 2) within the window of the application program (e.g., window 11 as shown in FIG. 2) are not to be resized prior to displaying the custom task pane (i.e., the add-in software loaded in step 204 (or already present on the computer) does not contain application code that resizes the window display), exemplary method 200 proceeds directly to step 216, bypassing step 215. From step 216, exemplary method 200 proceeds to decision block 217, whether a determination is made by the user as to whether the custom task pane is to be moved from a first location of the window to some other location. If at decision block 217 a determination is made by the user to move the custom task pane from a first location of the window to some other location, exemplary method 200 proceeds to step 218, wherein a user clicks on a portion of the custom task pane using a selection option of a selection device, such as a button on a mouse, and holds the selection option of a selection device in an activated position (e.g., holding the button on a mouse in a “down” position). Step 218 proceeds to step 219, wherein a user moves the custom task pane from the first location.

Exemplary method 200 proceeds from step 219 to decision block 220, whether a determination is made by the user as to whether the custom task pane is to be docked in a docking location in the window of the application program (e.g., window 11 as shown in FIG. 2). If at decision block 220 a determination is made by the user to move the custom task pane from a first location of the window to a docking location in the window of the application program, exemplary method 200 proceeds to step 221, wherein a user moves the custom task pane from a first location of the window to a docking location in the window of the application program. If at decision block 220 a determination is made by the user not to dock the custom task pane, exemplary method 200 proceeds from decision block 220 to step 222, wherein a user moves the custom task pane from a first location of the window to a non-docking location on the desktop (e.g., desktop 10 as shown in FIG. 2) or the window of the application program (e.g., window 11 as shown in FIG. 2).

From either of steps 221 or 222, exemplary method 200 proceeds to step 223 shown in FIG. 4C, wherein at least one of functions B₁ to B_{N} is selected by a user from the custom task pane. As shown in FIG. 4B, if at decision block 217 a determination is made by the user not to move the custom task pane from a first location of the window to some other location, exemplary method 200 proceeds directly to step 223.

Exemplary method 200 proceeds from step 223 to decision block 224, wherein a determination is made by the user as to whether at least one function A₁ to A_{M} provided in the original application program (i.e., the application program prior to loading the add-in software in step 204) is to be used (M being an integer as discussed above). If at least one function A₁ to A_{M} provided in the original application program is to be used by the user, exemplary method 200 proceeds to decision block 225, wherein a determination is made by the user as to whether the at least one function A₁ to A_{M} is accessible via a tool bar menu item. If the at least one function A₁ to A_{M} is accessible via a tool bar menu item, exemplary method 200 proceeds to step 226, wherein the at least one function A₁ to A_{M} is selected by the user from a tool bar menu item. From step 226, exemplary method 200 proceeds to decision block 233 discussed below and shown in FIG. 4D.

Returning to decision block 225, if a determination is made by the user that the at least one function A₁ to A_{M} is not accessible via a tool bar menu item, exemplary method 200 proceeds to decision block 227, wherein a determination is made by the user as to whether the at least one function A₁ to A_{M} is accessible via a native task pane option. If the at least one function A₁ to A_{M} is accessible via a native task pane option, exemplary method 200 proceeds to decision block 228, wherein a determination is made by the user as to whether the native task pane is displayed to the user. If the native task pane is not displayed to the user, exemplary method 200 proceeds to step 229, wherein the native task pane is opened by the user for display to the user. Step 229 then proceeds to step 230, wherein the at least one function A₁ to A_{M} is selected by the user from a native task pane option. If at decision block 228 a determination is made by the user that the native task pane is displayed to the user, exemplary method 200 proceeds directly to step 230, bypassing step 229. From step 230, exemplary method 200 proceeds to decision block 233 discussed below and shown in FIG. 4D.

Returning to decision block 227, if a determination is made by the user that the at least one function A₁ to A_{M} is not accessible via a native task pane option, exemplary method 200 proceeds to decision block 231, wherein a determination is made by the user as to whether the at least one function A₁ to A_{M} is accessible via some other post-display application option (described above) (e.g., options available to the user when the user right clicks on an application window). If a determination is made by the user that the at least one function A₁ to A_{M} is accessible via some other post-display application option, exemplary method 200 proceeds to step 232, wherein the at least one function A₁ to A_{M} is selected by the user via some other post-display application option. From step 232, exemplary method 200 proceeds to decision block 233 discussed below and shown in FIG. 4D.

Returning to decision block 231, if a determination is made by the user that the at least one function A₁ to A_{M} is not accessible via some other post-display application option (e.g., options available to the user when the user right clicks on an application window), exemplary method 200 proceeds directly to decision block 233 discussed below. It should be noted that exemplary method 200 proceeds directly from decision block 224 to decision block 225 to decision block 227 to decision block 231 to decision block 233 in an embodiment wherein the native task pane is automatically displayed to the user as a component of a window of an application program (e.g., window 11 as shown in FIG. 2) when the window of the application program is initially displayed to the user upon starting up of the application program.

Returning to decision block 224, if a determination is made by the user not to use at least one function A₁ to A_{M} provided in the original application program, exemplary method 200 proceeds directly to decision block 233 shown in FIG. 4D.

At decision block 233, a determination is made by the user as to whether another function B₁ to B_{N} is to be selected from the custom task pane by a user. If at decision block 223 a determination is made by the user to use at least one additional function B₁ to B_{N} from the custom task pane, exemplary method 200 proceeds to decision block 234, wherein a determination is made by the user as to whether the custom task pane is still displayed to the user. If at decision block 234 a determination is made by the user that the custom task pane is still displayed to the user, exemplary method 200 proceeds to block 235, which directs exemplary method 200 back to step 223. If at decision block 234 a determination is made by the user that the custom task pane is not displayed to the user, exemplary method 200 proceeds to block 236, which directs exemplary method 200 back to decision block 206.

Returning to decision block 233, if a determination is made by the user not to use another function B₁ to B_{N} from the custom task pane, exemplary method 200 proceeds to step 237, wherein the application program file is saved. Step 237 proceeds to end block 238, which represents the end of exemplary method 200.

Computer readable medium having stored thereon computer-executable instructions for generating and displaying a custom task pane are also disclosed herein. In one exemplary embodiment, the computer readable medium comprise computer readable medium having stored thereon computer-executable instructions for generating and displaying (i) a native task pane in a first location of a window of an application program, wherein the native task pane provides a first set of functions to a user, and (ii) a custom task pane in a second location of the window, wherein the second location is different from the first location, and wherein the custom task pane provides a second set of functions to the user, the second set of functions being different from the first set of functions. In this embodiment, the native task pane and the custom task pane can be simultaneously displayed in the window of the application program.

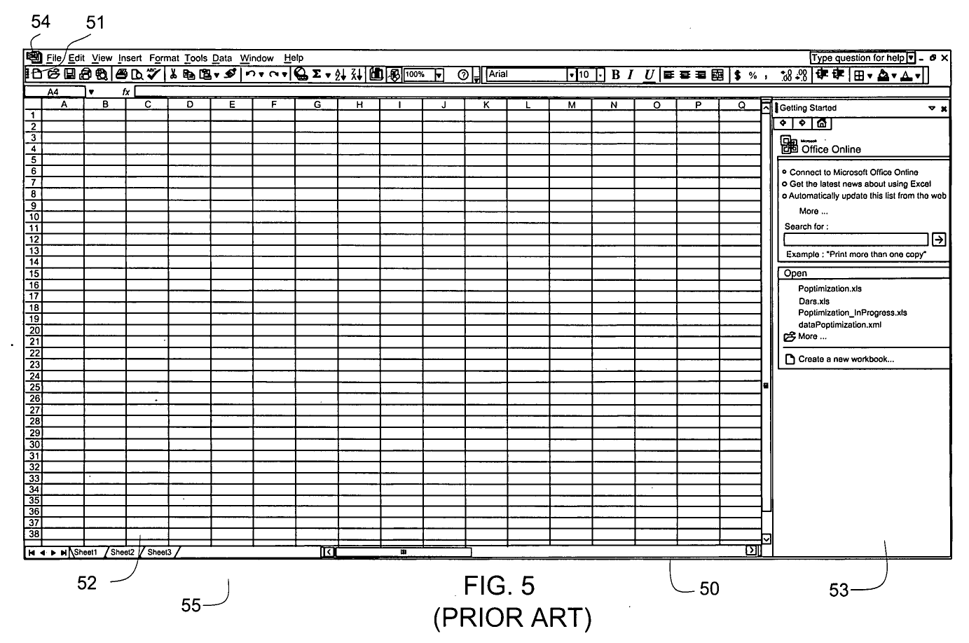

In one exemplary embodiment, the computer readable medium and computer-executable instructions stored thereon may be used to generate and display (i) a native task pane and (ii) a custom task pane in a window of a spreadsheet application program. Such an exemplary embodiment is depicted in exemplary screenshots shown in FIGS. 5-8.

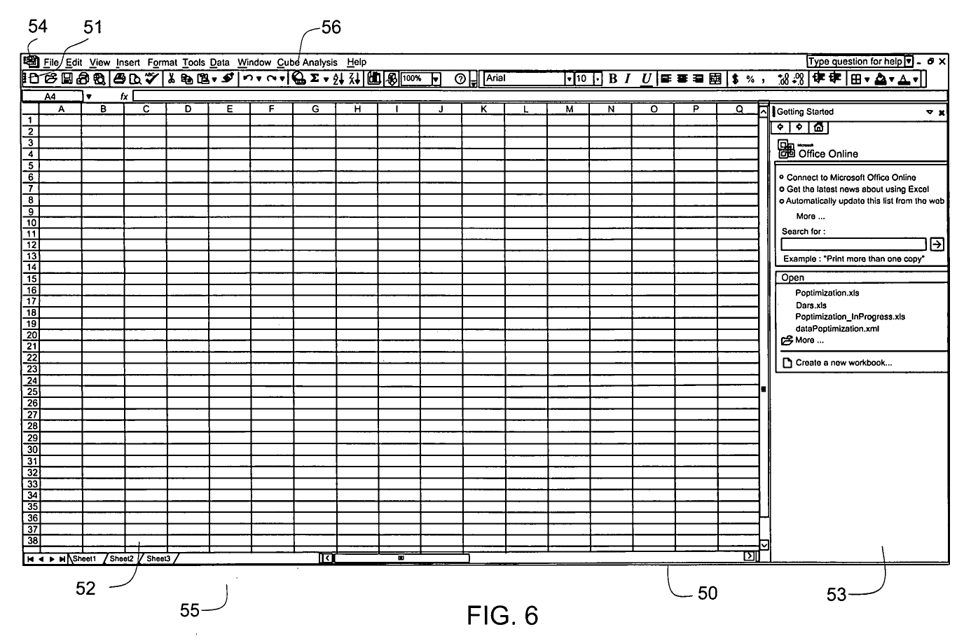

FIG. 5 shows exemplary screenshot 55 of an exemplary spreadsheet application program prior to modifying the exemplary spreadsheet application program with a software add-in. As shown in FIG. 5, exemplary screenshot 55 comprises tool bar menu 51, main spreadsheet area 52, and native task pane 53 positioned in a right-hand side docking location of application window 50. As shown along menu line 54 of tool bar menu 51, the exemplary spreadsheet application program provides original application functions in the following order: File, Edit, View, Insert, Format, Tools, Data, Window, and Help. Once an exemplary software add-in has been utilized, exemplary screenshot 55 is modified as shown in FIG. 6.

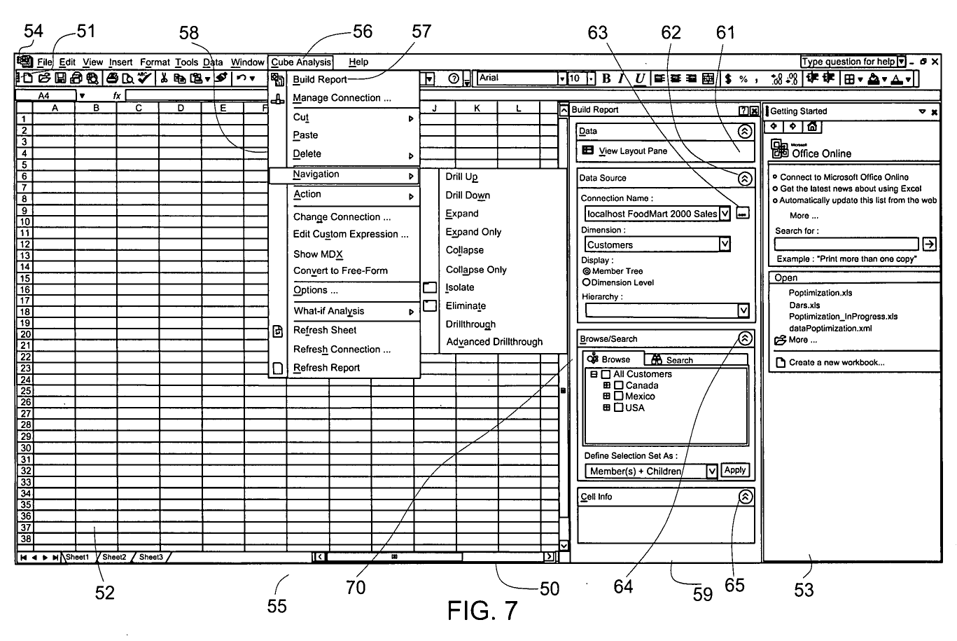

As shown in FIG. 6, exemplary screenshot 55 is modified to provide an additional option along menu line 54 of tool bar menu 51. In this exemplary embodiment, the add-in modifies the original exemplary spreadsheet application program to provide application options in the following order: File, Edit, View, Insert, Format, Tools, Data, Window, Cube Analysis, and Help. Cube Analysis option 56, shown in exemplary screenshot 55, may be used to access a custom task pane as shown in FIG. 7.

FIG. 7 depicts exemplary screenshot 55 once a user has selected (i.e., clicked on) Cube Analysis option 56, and subsequently, selected (i.e., clicked on) Build Report option 57 located in sub-task folder 58 under Cube Analysis option 56. Selection of Build Report option 57 causes the exemplary spreadsheet application program to display exemplary report-building custom task pane 59. As shown in FIG. 7, exemplary report-building custom task pane 59 desirably has similar task pane dimensions and a similar color scheme as native task pane 53.

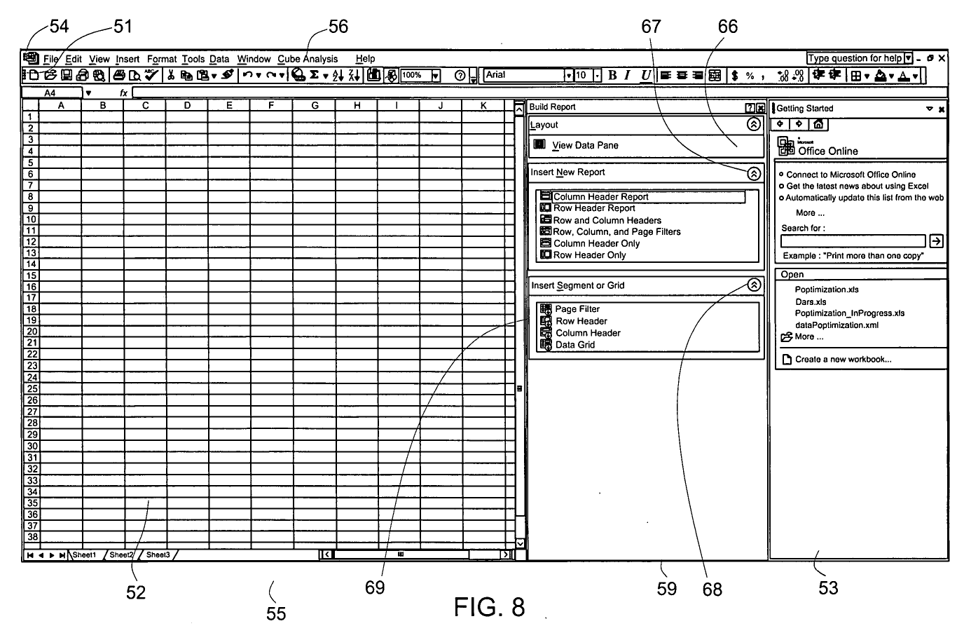

In this exemplary embodiment, exemplary report-building custom task pane 59 provides numerous functions to a user to enable the user to create customized reports in a spreadsheet. In this exemplary embodiment, the report-building functions are not provided in any portion of the original exemplary spreadsheet application program, including tool bar menu 51. As shown in FIG. 7, the report-building functions are provided in a first data pane 70 within exemplary report-building custom task pane 59. First data pane 70 includes function 61, which allows a user to select a layout pane that provides additional report-building functions to a user (see, exemplary layout pane 69 in FIG. 8); function 62, which allows a user to select a particular data source for data to be incorporated into main spreadsheet area 52; function 63, which allows a user to select and/or provide a particular connection name for the data source; function 64, which allows a user to browse or search for a particular data source file from a list of possible data source files; and function 65, which allows a user to view cell information relating to cells within a select data source file.

If a user selects function 61 shown in FIG. 7, layout pane 69 appears in exemplary report-building custom task pane 59 as shown in FIG. 8. Layout pane 69 include function 66, which allows a user to view data pane 70 described above; function 67, which allows a user to select layout details for a report to be incorporated into main spreadsheet area 52; and function 68, which allows a user to select a report and input a layout segment (e.g., a row header) into a report to be incorporated into main spreadsheet area 52.

As shown in the exemplary screenshots of FIGS. 5-8, the present invention may be used to provide additional functionality to an existing application program. Although the exemplary screenshots of FIGS. 5-8 are directed to a spreadsheet application program, it should be understood that the present invention may be used to provide additional functionality to any application program including, but not limited to, the specific types of application programs described above, namely, word-processing application programs; presentation application programs; electronic mail application programs; drawing application programs; and structure generating application programs.

Computing systems are also disclosed herein. An exemplary computing system contains at least one application module usable on the computing system, wherein the at least one application module comprises application code loaded thereon, wherein the application code performs a method of generating and displaying a custom task pane in an application program as described above. The application code may be loaded onto the computing system using any of the above-described computer readable medium having thereon computer-executable instructions for generating and displaying a custom task pane in an application program as described above.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the disclosed methods, computer readable medium, and computing systems should be assessed as that of the appended claims and any equivalents thereto.

What is claimed is:

1. A computer readable medium having stored thereon computer-executable instructions for generating and displaying a custom task pane in an application program, wherein the custom task pane enables a user to (i) perform one or more functions that are not provided in the application program; (ii) perform one or more functions that are provided in the application program, but not provided in a native task pane of the application program; or (iii) both (i) and (ii).

2. The computer readable medium of claim 1, wherein the application program comprises a native task pane that provides a first set of functions to a user, said custom task pane providing a second set of functions to a user, said second set of functions being different from said first set of functions.

3. The computer readable medium of claim 1, wherein the medium further comprises computer-executable instructions for resizing window components of the application program prior to displaying the custom task pane so that (i) components of the window prior to displaying the custom task pane, and (ii) the custom task pane are simultaneously displayed to a user.

4. The computer readable medium of claim 1, wherein the application program provides a first set of functions to a user, said computer-executable instructions provide a second set of functions to a user without removing any functions in the first set of functions.

5. The computer readable medium of claim 1, wherein the application program comprises a native task pane having a first display layout viewable by a user, said first display layout comprising first task pane dimensions and a first task pane color scheme, said custom task pane having a second display layout viewable by a user, said second display layout comprising the first task pane dimensions and the first task pane color scheme.

6. The computer readable medium of claim 1, wherein the custom task pane is capable of hovering and docking in a window of the application program.

7. The computer readable medium of claim 1, wherein the custom task pane enables a user to perform one or more functions that are not provided in the application program, said one or more functions comprising a data importation function, a report building function, a drawing generation function, a structure generation function, or any combination thereof.

8. The computer readable medium of claim 1, wherein the custom task pane enables a user to perform one or more functions that are provided in the application program, but not provided in a native task pane of the application program, said one or more functions comprising a file save function, a file creation function, a file opening function, an edit function, a find function, a replace function, or any combination thereof.

9. The computer readable medium of claim 1, wherein the application program comprises a word processing application program, a spreadsheet application program, a presentation application program, an electronic mail application program, a drawing application program, or a structure generating application program.

10. A computing system containing at least one application module usable on the computing system, wherein the at least one application module comprises application code loaded thereon from the computer readable medium of claim 1.

11. A method of generating and displaying a custom task pane in an application program, said method comprising the steps of:
providing at least one application program feature, wherein initiation of the at least one application program feature by a user generates and displays a custom task pane to the user; and
in response to an initiation step by a user, generating and. displaying a custom task pane to the user,
wherein the custom task pane enables a user to (i) perform one or more functions that are not provided in the application program; (ii) perform one or more functions that are provided in the application program, but not provided in a native task pane of the application program; or (iii) both (i) and (ii).

12. The method of claim 11, wherein the at least one application program feature comprises at least one tool bar menu option, and the initiation step comprises selecting the at least one tool bar menu option.

13. The method of claim 11, wherein the at least one application program feature comprises at least one native task pane menu option, and the initiation step comprises selecting the at least one native task pane menu option.

14. The method of claim 11, further comprising:
resizing window components of the application program prior to displaying the custom task pane so that (i) components of the window prior to displaying the custom task pane, and (ii) the custom task pane are simultaneously displayed to a user.

15. The method of claim 11, wherein the application program comprises a word processing application program, a spreadsheet application program, a presentation application program, an electronic mail application program, a drawing application program, or a structure generating application program.

16. The method of claim 15, wherein the application program comprises a spreadsheet application program.

17. A computer readable medium having stored thereon computer-executable instructions for performing the method of claim 11.

18. A computing system containing at least one application module usable on the computing system, wherein the at least one application module comprises application code for performing the method of claim 11.

19. A computer readable medium having stored thereon computer-executable instructions for generating and displaying (i) a native task pane in a first location of a window of an application program, said native task pane providing a first set of functions to a user, and (ii) a custom task pane in a second location of the window, wherein the second location is different from the first location, said custom task pane providing a second set of functions to the user, said second set of functions being different from said first set of functions, wherein the native task pane and the custom task pane can be simultaneously displayed in the window.

20. The computer readable medium of claim 19, wherein the application program comprises a word processing application program, a spreadsheet application program, a presentation application program, an electronic mail application program, a drawing application program, or a structure generating application program.
